(19) United States
(12) Patent Application Publication
(10) Pub. No.: US 2018/0251016 A1
(43) Pub. Date: Sep. 6, 2018

(54) HYBRID VEHICLE DRIVE DEVICE

(71) Applicant: AISIN SEIKI KABUSHIKI KAISHA, Kariya-shi (JP)

(72) Inventors: Shinya HARADA, Adachi-ku (JP); Takahiro MISU, Nagoya-shi (JP); Shota HIROSE, Toyoake-shi (JP); Takeshi TOJO, Chiryu-shi (JP); Tomoyuki TOYAMA, Chita-shi (JP); Yoshiyuki KOMI, Hamamatsu-shi (JP)

(73) Assignee: AISIN SEIKI KABUSHIKI KAISHA, Kariya-shi (JP)

(21) Appl. No.: 15/754,888

(22) PCT Filed: Aug. 23, 2016
(86) PCT No.: PCT/JP2016/074564

§ 371 Date: Feb. 23, 2018

(30) Foreign Application Priority Data
Aug. 27, 2015 (JP) 2015-167852

(51) Int. Cl. B60K 6/36; B60K 6/383; B60K 6/442; B60K 6/52; B60L 11/14; F16H 3/083

(52) U.S. Cl. CPC B60K 6/36; B60K 6/383; B60K 6/442; B60K 2006/4825; B60L 11/14; F16H 3/083; B60K 6/52

(57) ABSTRACT

A hybrid vehicle drive device includes a first motor/generator, a second motor/generator, an input shaft to which an engine is rotatably connected, an output shaft which is rotatably connected to a drive wheel and the second motor/generator, a rotational member which is rotatably connected to the first motor/generator and the output shaft, and a first one-way clutch which connects the input shaft and the rotational member with each other when a rotation speed of the input shaft is faster than a rotation speed of the rotational member and disconnects the input shaft and the rotational member from each other when the rotation speed of the input shaft is slower than the rotation speed of the rotational member.

### BACKGROUND OF THE TECHNOLOGY

Conventionally, a hybrid vehicle drive device has been proposed as disclosed in Patent Literature 1, wherein the hybrid vehicle drive device has two motor/generators and one engine. The hybrid vehicle drive device of this conventional type has a first clutch which connects or disconnects the engine and the output shaft and a second clutch which connects or disconnects a first motor/generator and the output shaft.

### DOCUMENT LIST OF STATE OF ART

### Patent Document

Patent Literature 1: JP2012-176730 A

### DISCLOSURE OF INVENTION

### Problems to be Solved

However, according to the hybrid vehicle drive device disclosed in the Patent literature 1, the first clutch which has been in disconnected state is connected when the engine torque which is outputted from the engine is transmitted to the output shaft. Upon such connection, since the there exists a rotation speed difference between the connecting elements which are to be connected by the first clutch and the engine inertia force is inputted to the gears forming the hybrid vehicle drive device via the first clutch and such excess force is applied on the gears to thereby give a bad influence thereon.

The present invention was made in consideration with the above problems and the object of the invention is to provide a hybrid vehicle drive device equipped with motor/generator and engine that would not generate an excess force applied on the gears forming the hybrid vehicle drive device upon connection of the engine with the output shaft.

### Means for Solving the Problem

In order to solve the above conventional problems, the hybrid vehicle drive device associated with the invention of claim 1 is characterized in that the hybrid vehicle drive device includes a first motor/generator, a second motor/generator, an input shaft to which an engine is rotatably connected, an output shaft which is roratably connected to a drive wheel and the second motor/generator, a rotational member which is rotatably connected to the first motor/generator and the output shaft and a first one-way clutch which connects the input shaft and the rotational member when a rotation speed of the input shaft is faster than a rotation speed of the rotational member and disconnects the input shaft and the rotational member when the rotation speed of the input shaft is slower than the rotation speed of the rotational member.

As explained above, the first one-way clutch of the invention connects the input shaft and the rotational member when the rotation speed of the input shaft is faster than the rotation speed of the rotational member. Accordingly, while the engine is outputting an engine torque, if the rotation speed of the input shaft becomes faster than the rotation speed of the rotational member, the input shaft and the rotational member are connected by the first one-way clutch and therefore the engine and the output shaft are connected. In other words, the input shaft and the rotational member are connected by the first one-way clutch under no rotation speed difference being generated between the input shaft and the rotational member. Therefore, the force due to an inertia force of the engine is not inputted to each gear forming the hybrid vehicle drive device and accordingly, no excessive force is applied to the gears forming the hybrid vehicle drive device.

### BRIEF EXPLANATION OF ATTACHED DRAWINGS

FIG. 1 is an explanatory schematic view of a vehicle in which the hybrid vehicle drive device of the first embodiment of the invention is installed;

FIG. 2 is an engagement table of the hybrid vehicle drive device according to the first and the second embodiments of the invention;

FIG. 3 is an explanatory schematic view of a vehicle in which the hybrid vehicle drive device of the second embodiment of the invention is installed;

FIG. 4 is an explanatory schematic view of a vehicle in which the hybrid vehicle drive device of the third embodiment of the invention is installed; and

FIG. 5 is an engagement table of the hybrid vehicle drive device according to the third embodiment of the invention;

### THE EMBODIMENTS FOR IMPLEMENTING THE INVENTION

(Explanation of Vehicle)

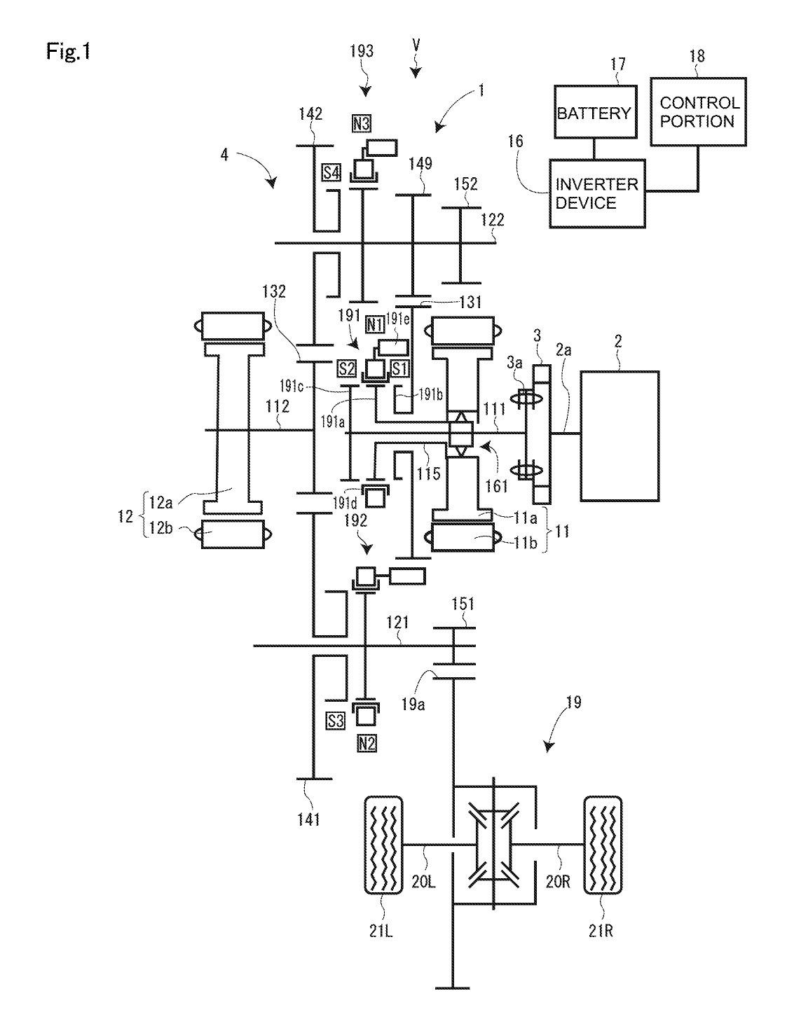

The vehicle V in which the hybrid vehicle drive device 1 of the embodiment (first embodiment) of the present invention is installed will be explained with reference to FIG. 1. As shown in FIG. 1, the vehicle V includes the hybrid vehicle drive device 1, a differential 19, drive axles 20L and 20R and drive wheels 21L, and 21R. The hybrid vehicle drive device 1 includes an engine 2, a flywheel 3, an automatic transmission 4, a first motor/generator 11, a second motor/generator 12 an inverter device 16 a battery 17 and a control portion 18.

The engine 2 uses a hydrocarbon fuel, such as gasoline or kerosene as the fuel and the type of engine is a gasoline driven engine or a diesel driven engine which outputs engine torque Te to the drive shaft 2a. The flywheel 3 is connected to the drive shaft 2a and is provided with a damper 3a which absorbs the variation of the engine torque Te inputted from the engine 2. The automatic transmission 4 will be explained later in detail.

The first motor/generator 11 is formed by a first rotor 11a and a first stator 11b. The first rotor 11a is rotatably attached to the inner peripheral side of the first stator 11b. The second motor/generator 12 is formed by a second rotor 12a and a second stator 12b. The second rotor 12a is rotatably attached to the inner peripheral side of the second stator 12b. The battery 17 is a secondary battery which charges electricity and supplies the first stator 11b of the first motor/generator 11 and the second stator 12b of the second motor/generator 12 via the inverter device 16 with the electricity.

The inverter device 16 raises the electric voltage of the electricity supplied from the battery 17 and supplies the first stator 11b of the first motor/generator 11 and the second stator 12b of the second motor/generator 12 with the electricity with the raised voltage thereby to drive the first motor/generator 11 and the second motor/generator 12 based on the instructions from the control portion 18. Further, the inverter device 16 lowers the electric voltage of the electricity generated at the first motor/generator 11 and the second motor/generator 12 to thereby charge the battery 17 based on the instructions from the control portion 18. When the brake pedal (not shown) is depressed, the control portion 18 outputs the instructions to the inverter device 16 to generate electricity at least at one of the first and second motor/generators 11 and 12 to the inverter device 16 to generate a regeneration braking force.

The differential 19 transmits torque outputted from the automatic transmission 4 to the right and the left drive wheels 21R, 21L via the drive axle 20R and the drive axle 20L respectively and at the same time absorbs the rotation speed difference between the right and the left drive wheels 21R and 21L.

(Automatic Transmission)

The automatic transmission 4 will be explained hereinafter. The automatic transmission 4 includes a first input shaft 111, a second input shaft 112, a rotational member 115, a first output shaft 121, a second output shaft 122, a first drive gear 131, a second drive gear 132, a first driven gear 141, a second driven gear 142, an over-drive driven gear 149, a first output gear 151, a second output gear 152, a one-way clutch 161, a first connecting mechanism 191, a second connecting mechanism 192 and a third connecting mechanism 193.

The first input shaft 111 (corresponding to the input shaft of the invention of claims) is provided coaxially with the drive shaft 2a and is arranged in series therewith. The first input shaft 111 is rotatably connected to the drive shaft 2a of the engine 2 via the flywheel 3. The rotational member 115 is in cylindrical shape and is provided at the outer periphery side of the first input shaft 111 and is arranged coaxially therewith. The second input shaft 112 is provided coaxially with the first input shaft 111 and is arranged in series therewith. The first output shaft 121 (corresponding to the output shaft of the invention of claims) and the second output shaft 122 (corresponding to the output shaft of the invention of claims) are arranged in parallel with the first input shaft 111 and the second input shaft 112 in a radial direction.

The first rotor 11a of the first motor/generator 11 is rotatably connected to the rotational member 115. One-way clutch 161 (corresponding to the first one-way clutch of the invention of claims) is provided between the first input shaft 111 and the rotational member 115. The one-way clutch 161 becomes in a locked state when the rotation speed of the first input shaft 111, i.e., the rotation speed of the engine 2 is faster than the rotational member 115, i.e., the rotation speed of the first rotor 11a and under this state the first input shaft 111 and the rotational member 115 are connected. On the other hand, the one-way clutch 161 becomes in a free state when the rotation speed of the first input shaft 111 is slower than the rotational member 115 and under this state the first input shaft 111 and the rotational member 115 are dis-connected. The first drive gear 131 is freely rotatably provided at the rotational member 115.

The second drive gear 132 and the second rotor 12a of the second motor/generator 12 are fixed to the second input shaft 112. According to this structure, the second drive gear 132 (corresponding to the drive gear of the invention of claims) is rotatably connected to the second rotor 12a of the second motor/generator 12.

The first output gear 151 is fixed to the first output shaft 121 and is engaged with a ring gear 19a of the differential 19. Under this structure, the first output shaft 121 is rotatably connected to the drive wheels 21L and 21R. The first driven gear 141 is freely rotatably connected to the first output shaft 121 and is engaged with the second drive gear 132. Under this structure, as will be explained later, the second motor/generator 12 is rotatably connected to the first output shaft 121 when the first driven gear 141 is connected to the first output shaft 121.

The over-drive driven gear 149 is fixed to the second output shaft 122 and is engaged with the first drive gear 131. Under this structure, as will be explained later, the rotational member 115 is rotatably connected to the second output shaft 122 when the first drive gear 131 is connected to the rotational member 115 by the first connecting mechanism 191.

The second output gear 152 is fixed to the second output shaft 122 and is engaged with the ring gear 19a of the differential 19. Under this structure, the second output shaft 122 is rotatably connected to the drive wheels 21L and 21R. The gear diameter of the second output gear 152 is set to be larger than the gear diameter of the first output gear 151.

The second driven gear 142 is freely rotatably provided at the second output shaft 122 and is engaged with the second drive gear 132. Under this structure, as will be explained later, the second motor/generator 12 is rotatably connected to the second output shaft 122 when the second driven gear 142 is connected to the second output shaft 122. The gear diameter of the second driven gear 142 is set to be smaller than the gear diameter of the first driven gear 141.

The first connecting mechanism 191 includes a dog clutch which changes the shift position to any one of the first shift position S1 where the first drive gear 131 is connected to the rotational member 115, the second shift position S2 where the first input shaft 111 is connected to the rotational member 115 and the first neutral position N1 where any one of the first drive gear 131 and the first input shaft 111 is not connected to the rotational member 115. In other words, the first connecting mechanism 191 connects or disconnects the first drive gear 131 or the first input shaft 111 with or from the rotational member 115. The first connecting mechanism 191 is formed by a first hub 191a, a first engaging member 191b, a second engaging member 191c, a first sleeve 191d and a first actuator 191e.

The first hub 191a is fixed to the rotational member 115. The first engaging member 191b is fixed to the first drive gear 131 and is arranged neighboring to the first hub 191a. The second engaging member 191c is fixed to the first input shaft 111 and is arranged neighboring to the first hub 191a. The first sleeve 191d is in spline engagement with the first hub 191a and is selectively engaged with the first engaging member 191b or the second engaging member 191c and is not engaged with both of the first engaging member 191b and the second engaging member 191c at a time.

The first actuator 191e shifts the first sleeve 191d to any one of the first neutral position N1, the first shift position S1 and the second shift position S2 based on the instructions from the control portion 18. Under the first sleeve 191d being in the first neutral position N1, the first hub 191a is not engaged with any of the first engaging member 91b and the second engaging member 191c. Under the first sleeve 191d being in the first shift position S1, the first hub 191a is engaged with the first engaging member 191b and therefore, the first drive gear 131 is connected to the rotational member 115. Under the first sleeve 191d being in the second shift position S2, the first hub 191a is engaged with the second engaging member 191c and therefore the first input shaft 111 is connected to the rotational member 115.

The second connecting mechanism 192 includes a dog clutch which changes the shift position to any one of the third shift position S3 where the first driven gear 141 is connected to the first output shaft 121 and the second neutral position N2 where the first driven gear 141 is disconnected from the first output shaft 121. In other words, the second connecting mechanism 192 connects or disconnects the first driven gear 141 with or from the first output shaft 121. The detail structure of the second connecting mechanism 192 is the same with the first connecting mechanism 191 and therefore the explanation thereof is omitted.

The third connecting mechanism 193 includes a dog clutch which changes the shift position to any one of the fourth shift position S4 where the second driven gear 142 is connected to the second output shaft 122 and the third neutral position N3 where the second driven gear 142 is disconnected from the second output shaft 122. In other words, the third connecting mechanism 193 connects or disconnects the second driven gear 142 with or from the second output shaft 122. The detail structure of the third connecting mechanism 193 is the same with the first connecting mechanism 191 and therefore the explanation thereof is omitted.

(Mode of Hybrid Vehicle Drive Device According to First Embodiment)

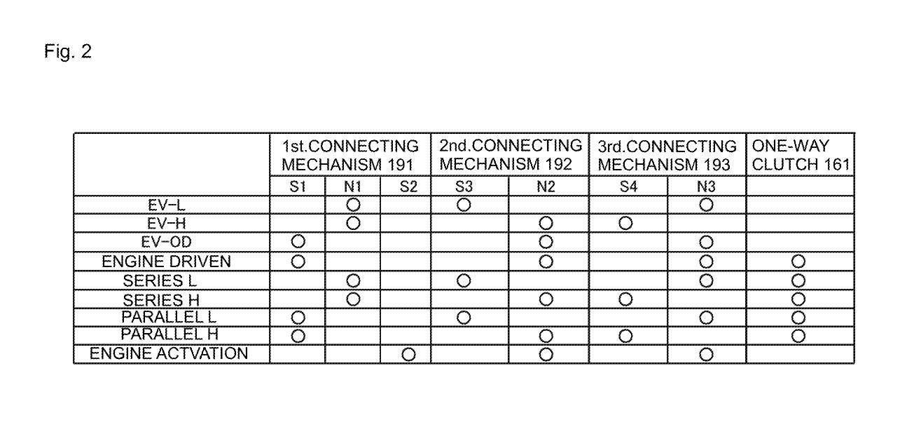

The driving mode of the hybrid vehicle drive device 1 according to the first embodiment will be explained with reference to the engagement table shown in FIG. 2.

[EV-L]

The EV-L is the mode that the vehicle V is driven to travel only by the driving force of the second motor/generator 12. The control portion 18 outputs instructions to the connecting mechanisms 191 through 193 so that the respective shift positions thereof correspond to the column of EV-L shown in the engagement table of FIG. 2 to establish the EV-L mode in the automatic transmission 4. When the EV-L mode is established in the automatic transmission 4, the first driven gear 141 is connected to the first output shaft 121 and the second motor/generator 12 is rotatably connected to the drive wheels 21L and 21R. Then the second motor torque Tm2 outputted from the second motor/generator 12 is transmitted to the drive wheels 21L and 21R via the first output shaft 121.

[EV-H]

The EV-H is the mode that the vehicle V is driven to travel only by the driving force of the second motor/generator 12. In the EV-H mode, the reduction gear ratio between the second motor/generator 12 and the drive wheels 21L and 21R is smaller than the reduction gear ratio therebetween in the EV-L mode. The control portion 18 outputs instructions to the connecting mechanisms 191 through 193 so that the respective shift positions thereof correspond to the column of EV-H shown in the engagement table of FIG. 2 to establish the EV-H mode in the automatic transmission 4. When the EV-H mode is established in the automatic transmission 4, the second driven gear 142 is connected to the second output shaft 122 and the second motor/generator 12 is rotatably connected to the drive wheels 21L and 21R. Then the second motor torque Tm2 outputted from the second motor/generator 12 is transmitted to the drive wheels 21L and 21R via the second output shaft 122.

[EV-OD]

The EV-OD is the mode that the vehicle V is driven to travel by the first motor/generator 11. In the EV-OD mode, the reduction gear ratio between the first motor/generator 11 and the drive wheels 21L and 21R is smaller than the reduction gear ratio between the second motor/generator 12 and the drive wheels 21L and 21R in the EV-H. The control portion 18 outputs instructions to the connecting mechanisms 191 through 193 so that the respective shift positions thereof correspond to the column of EV-OD shown in the engagement table of FIG. 2 to establish the EV-OD mode in the automatic transmission 4. When the EV-OD mode is established in the automatic transmission 4, the first drive gear 131 is connected to the rotational member 115 and the first motor/generator 11 is rotatably connected to the drive wheels 21L and 21R. Then the first motor torque Tm1 outputted from the first motor/generator 11 is transmitted to the drive wheels 21L and 21R via the second output shaft 122. It is noted that the deceleration of the vehicle V can be prevented by establishing the EV-OD mode during the speed change operation between the EV-L and the EV-H thereby to output the first motor torque Tm1 from the first motor/generator 11 to the drive wheels 21L and 21R.

[Engine Driven]

The “Engine Driven” is the mode that the vehicle V is driven to travel by the driving force of the engine 2. The control portion 18 outputs instructions to the connecting mechanisms 191 through 193 so that the respective shift positions thereof correspond to the column of “Engine Driven” shown in the engagement table of FIG. 2 to establish the Engine Driven mode in the automatic transmission 4. When the Engine Driven mode is established in the automatic transmission 4, the first drive gear 131 is connected to the rotational member 115 and the one-way clutch 161 becomes in a locked state when the engine 2 outputs the engine torque Te. Then the first input shaft 111 and the rotational member 115 are connected to transmit the engine torque Te to the drive wheels 21L and 21R via the second output shaft 122. In this case, the first motor/generator 11 is driven to travel by the driving force of the engine 2 and the first motor/generator 11 generates electricity to supply auxiliary machines with the electricity. Further, it is noted that when the required driving force is great, the vehicle V is driven to travel by both the engine 2 and the first motor/generator 11 in the Engine Driven mode.

[Series L]

The “Series L” is the mode that vehicle V is driven to travel by the driving force of the second motor/generator 12 by driving the first motor/generator 11 by the engine 2 to generate the electricity at the first motor/generator 11. The control portion 18 outputs instructions to the connecting mechanisms 191 through 193 so that the respective shift positions thereof correspond to the column of “Series L” shown in the engagement table of FIG. 2 to establish the Series L mode in the automatic transmission 4. When the Series L mode is established in the automatic transmission 4, the first driven gear 141 is connected to the first output shaft 121 and the second motor/generator 12 is rotatably connected to the drive wheels 21L and 21R. Since the engine 2 is driven and the first input shaft 111 is rotated, the one-way clutch 161 is locked and the first motor/generator 11 is driven by the engine 2 thereby to generate the electricity at the first motor/generator 11. The electricity generated at the first motor/generator 11 is used for driving the second motor/generator 12 and the second motor torque Tm2 outputted from the second motor/generator 12 is transmitted to the drive wheels 21L and 21R via the first output shaft 121.

[Series H]

The Series H is the mode that the vehicle V is driven to travel by the driving force of the second motor/generator 12 by driving the first motor/generator 11 by the engine 2 to generate electricity at the first motor/generator 11. In the Series H mode, the reduction gear ratio between the second motor/generator 12 and the drive wheels 21L and 21R is smaller than the reduction gear ratio between the second motor/generator 12 and the drive wheels 21L and 21R in the Series L mode. The control portion 18 outputs instructions to the connecting mechanisms 191 through 193 so that the respective shift positions thereof correspond to the column of Series H shown in the engagement table of FIG. 2 to establish the Series H mode in the automatic transmission 4. When the Series H mode is established in the automatic transmission 4, the second driven gear 142 is connected to the second output shaft 122 and the second motor/generator 12 is rotatably connected to the drive wheels 21L and 21R. Then the engine 2 is driven to rotate the first motor/generator 11 and the one-way clutch 161 becomes in a locked state and the first motor/generator 11 is driven by the engine 2 to generate the electricity. The electricity generated at the first motor/generator 11 is used for driving the second motor/generator 12 and the second motor torque Tm2 outputted from the second motor/generator 12 is transmitted to the drive wheels 21L and 21R via the second output shaft 122.

[Parallel L]

The Parallel L is the mode that the vehicle V is driven to travel by the engine 2 and the driving force of the second motor/generator 12. The control portion 18 outputs instructions to the connecting mechanisms 191 through 193 so that the respective shift positions thereof correspond to the column of Parallel L shown in the engagement table of FIG. 2 to establish the Parallel L mode in the automatic transmission 4. When the Parallel L mode is established in the automatic transmission 4, the first drive gear 131 is connected to the rotational member 115 and the first motor/generator 11 is rotatably connected to the drive wheels 21L and 21R. Further, the first driven gear 141 is connected to the first output shaft 121. Since the engine 2 is driven to rotate the first motor/generator 11, the one-way clutch 161 becomes in a locked state and the engine torque Te outputted from the engine 2 is transmitted to the first motor/generator 11 and the drive wheels 21L and 21R. The electricity generated at the first motor/generator 11 is used for driving the second motor/generator 12 and the second motor torque Tm2 outputted from the second motor/generator 12 is transmitted to the drive wheels 21L and 21R via the first output shaft 121. In some case, the first motor/generator 11 is operated as an electric motor to output the first motor torque Tm1 which is transmitted to the drive wheels 21L and 21R via the second output shaft 122.

[Parallel H]

The Parallel H is the mode that the vehicle V is driven to travel by the engine 2 and the driving force of the second motor/generator 12. In the Parallel H mode, the reduction gear ratio between the second motor/generator 12 and the drive wheels 21L and 21R is smaller than the reduction gear ratio between the second motor/generator 12 and the drive wheels 21L and 21R in the Parallel L mode. The control portion 18 outputs instructions to the connecting mechanisms 191 through 193 so that the respective shift positions thereof correspond to the column of Parallel H shown in the engagement table of FIG. 2 to establish the Parallel H mode in the automatic transmission 4. When the Parallel H mode is established in the automatic transmission 4, the first drive gear 131 is connected to the rotational member 115 and the first motor/generator 11 is rotatably connected to the drive wheels 21L and 21R. Further, the second driven gear 142 is connected to the output shaft 122. Since the engine 2 is driven to rotate the first input shaft 111, the one-way clutch 161 becomes in a locked state and the engine torque Te outputted from the engine 2 is transmitted to the first motor/generator 11 and the drive wheels 21L and 21R. The electricity generated at the first motor/generator 11 is used for driving the second motor/generator 12 and the second motor torque Tm2 outputted from the second motor/generator 12 is transmitted to the drive wheels 21L and 21R via the second output shaft 122. In some case, the first motor/generator 11 is operated as an electric motor to output the first motor torque Tm1 which is transmitted to the drive wheels 21L and 21R via the second output shaft 122.

[Engine Activation]

The Engine Activation is the mode that the engine 2 is activated by the first motor/generator 11. The control portion 18 outputs instructions to the connecting mechanisms 191 through 193 so that the respective shift positions thereof correspond to the column of the Engine Activation shown in the engagement table of FIG. 2 to establish the Engine Activation mode in the automatic transmission 4. When the Engine Activation mode is established in the automatic transmission 4, the first rotor 11a of the first motor/generator 11 is connected to the first input shaft 111. The first motor torque Tm1 outputted from the first motor/generator 11 is transmitted to the engine 2 to activate the engine 2 thereby.

### Effects of the Embodiment

As apparent from the above explanation, the one-way clutch 161 connects the first input shaft 111 and the rotational member 115 when the rotation speed of the first input shaft 111 is faster than the rotation speed of the rotational member 115. Thus, when the engine 2 outputs engine torque Te and the rotation speed of the first input shaft 111 becomes faster than the rotation speed of the rotational member 115, the one-way clutch 161 connects the first input shaft 111 and the rotational member 115 to thereby connect the engine 2 and the second output shaft 122. In other words, the one-way clutch 161 connects the first input shaft 111 and the rotational member 115 under the state that no rotation speed difference is generated between the first input shaft 111 and the rotational member 115. Accordingly, the inertia force from the engine 2 is not inputted to each gear forming the hybrid vehicle drive device 1 to thereby eliminate any excess force to be applied to each gear forming the hybrid vehicle drive device 1.

Further, comparing the case that the friction clutch is used for connecting the first input shaft 111 and the rotational member 115, with the case that the one-way clutch 161 is used, the latter is less in cost and accordingly the cost of the hybrid vehicle drive device 1 as a whole can be reduced.

The first connecting mechanism 191 connects or disconnects the second output shaft 122 and the rotational member 115 by connecting or disconnecting the first drive gear 131 with or from the rotational member 115. Therefore, the first motor/generator 11 and the engine 2 can be disconnected from the second output shaft 122. This can switch over the travelling mode to the EV-L or EV-H mode .where the vehicle V is driven to travel only by the driving force of the second motor/generator 12. Further, by driving the engine 2 to drive the first motor/generator 11 to generate the electricity thereat. Thus, the travelling mode can be switched over to the Series L or Series H mode where the vehicle V is driven to travel by the driving force of the second motor/generator 12. As a result, the traveling mode can be appropriately changed depending on the vehicle speed of the vehicle V, the remaining amount of the battery 17 and the required driving force.

The first connecting mechanism 191 connects or disconnects the first input shaft 111 and the rotational member 115. Accordingly, by connecting the first input shaft 111 and the rotational member 115 by the first connecting mechanism 191, the first rotor 11a of the first motor/generator 11 and the engine 2 can be connected to activate the engine 2 by the first motor/generator 11 to be able to eliminate a motor exclusively used for activating the engine 2. This can reduce the cost of the hybrid vehicle drive device 1 as a whole.

By using the second connecting mechanism 192 and the third connecting mechanism 193, the state that the first driven gear 141 is connected to the first output shaft 121 and the state that the second driven gear 142 is connected to the second output shaft 122 can be switched over. Accordingly, the two different reduction ratios between the second motor/generator 12 and the drive wheels 21L and 21R can be realized and by switching over the reduction ratio from one to the other, the second motor/generator 12 can be effectively driven at the efficient rotation speed.

### Second Embodiment

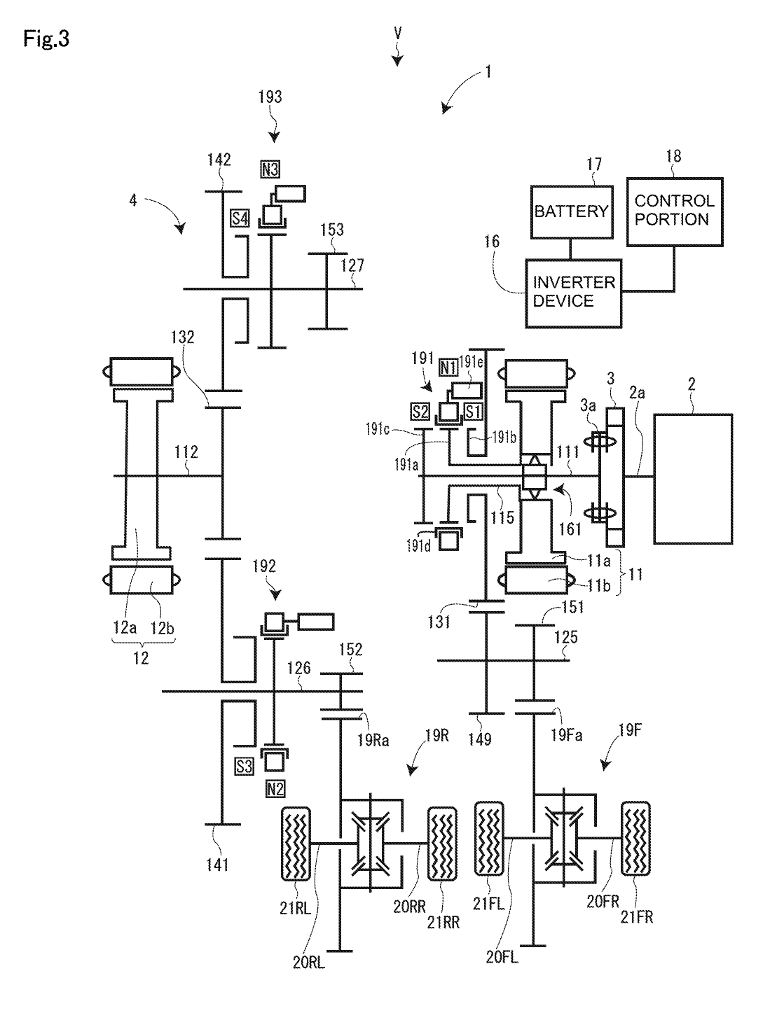

The hybrid vehicle drive device 1 according to the second embodiment will be explained hereinafter with reference to FIG. 3. The explanation will be made only the portions which are different from those of the first embodiment. The portions of the hybrid vehicle drive device 1 of the second embodiment shown in FIG. 3, which are the same with those of the hybrid vehicle drive device 1 of the first embodiment shown in FIG. 1 will be omitted from the explanation, by simply putting the same symbols or numerals in FIG. 3.

According to the hybrid vehicle drive device 1 of the second embodiment, both front and rear wheels 21FL and 21FR and 21RL and 21RR are structured to be the drive wheel. As shown in FIG. 3, in the hybrid vehicle drive device 1 of the second embodiment, at least one of the engine 2 and the first motor/generator 11 drives at least one side of the front and rear drive wheels 21FL and 21FR and 21RL and 21RR and the second motor/generator 12 drives the other side of the front and rear drive wheels 21FL and 21FR and 21RL and 21RR. The explanation of the second embodiment hereinafter will be made presuming that one of the engine 2 and the first motor/generator 11 drives the front side drive wheels 21FL and 21FR and the second motor/generator 12 drives the rear side drive wheels 21RL and 21RR.

A first output shaft 125 is provided in parallel with the first input shaft 111 in a radial direction. The first output gear 151 and the over-drive driven gear 149 are fixed to the first output shaft 125. The rotational member 115 is rotatably connected to the first output shaft 125 when the first drive gear 131 is connected to the rotational member 115 by the first connecting mechanism 191.

The first output gear 151 is engaged with the front side ring gear 19Fa of the front side differential 19F. The front side differential 19F is rotatably connected to the front side drive wheels 21FL and 21FR via the front side drive axles 20FL and 20FR. According to this structure, the first output shaft 125 is rotatably connected to the front side drive wheels 21FL and 21FR.

The low speed side second output shaft 126 (corresponding to the second output shaft of the invention of claims) and the high speed side second output shaft 127 (corresponding to the second output shaft of the invention of claims) are provided in parallel with the second input shaft 112 in a radial direction. The second output gear 152 is fixed to the low speed side second output shaft 126. The second output gear 152 is engaged with the rear side ring gear 19Ra of the rear side differential 19R. The rear side differential 19R is rotatably connected to the rear side drive wheels 21RL and 21RR via the rear side drive axles 2ORL and 2ORR. According to this structure, the low speed side second output shaft 126 is rotatably connected to the rear side drive wheels 21RL and 21RR. The first driven gear 141 is freely rotatably provided at the low speed side second output shaft 126. The second connecting mechanism 192 connects or disconnects the first driven gear 141 and the low speed side second output shaft 126. The second rotor 12a of the second motor/generator 12 is rotatably connected to the low speed side second output shaft 126 when the first driven gear 141 is connected to the low speed side second output shaft 126 by the second connecting mechanism 192. According to this structure, the low speed side second output shaft 126 is rotatably connected to the second rotor 12a of the second motor/generator 12.

The third output gear 153 is fixed to the high speed side second output shaft 127. The third output gear 153 is engaged with the rear side ring gear 19Ra of the rear side differential 19R. The second driven gear 142 is freely rotatably provided at the high speed side second output shaft 127. The third connecting mechanism 193 connects or disconnects the second driven gear 142 and the high speed side second output shaft 127. The second rotor 12a of the second motor/generator 12 is rotatably connected to the high speed side second output shaft 127 when the second driven gear 142 is connected to the high speed side second output shaft 127 by the third connecting mechanism 193.

The control portion 18 outputs the instructions to the connecting mechanisms 191 through 193 to change the driving modes of the hybrid vehicle drive device 1 according to the engagement table shown in FIG. 2.

According to the second embodiment, the hybrid vehicle drive device 1 can drive the front side drive wheels 21FL and 21FR and the rear side drive wheels 21RL and 21RR at the same time. Therefore, the possible slipping of the front and rear drive wheels 21FL, 21FR, 21RL and 21RR when the vehicle travels on a slippery snowy road can be suppressed.

The structure of the embodiment can be changed such that the first output shaft 125 is rotatably connected to the rear side drive wheels 21RL and 21RR and the low speed side second output shaft 126 and the high speed side second output shaft 127 are rotatably connected to the front side drive wheels 21FL and 21FR. In other words, according to such modified embodiment, at least one of the engine 2 and the first motor/generator 11 drives the rear side drive wheels 21RL and 21RR and the second motor/generator 12 drives the front side drive wheels 21FL and 21FR.

### Third Embodiment

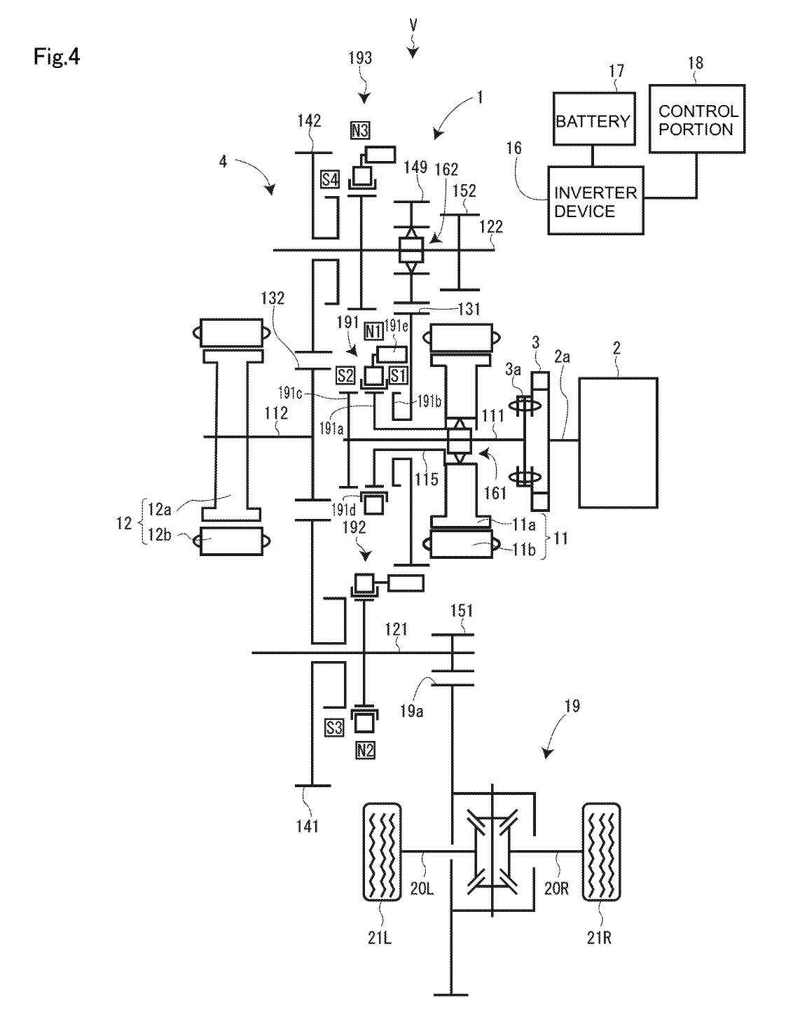

The hybrid vehicle drive device 1 according to the third embodiment will be explained with reference to FIG. 4. The explanation will be made only the portions which are different from those of the first embodiment. The portions of the hybrid vehicle drive device 1 of the third embodiment shown in FIG. 4, which are the same with those of the hybrid vehicle drive device 1 of the first embodiment shown in FIG. 1 will be omitted from the explanation, by simply putting the same symbols or numerals in FIG. 4.

As shown in FIG. 4, the hybrid vehicle drive device 1 according to the third embodiment is provided with the second one-way clutch 162 between the over-drive driven gear 149 (connecting member) and the second output shaft 122. The second one-way clutch 162 becomes in a locked state when the rotation speed of the over-drive driven gear 149 (connecting member) is faster than the rotation speed of the second output shaft 122 to connect the over-drive driven gear 149 with the second output shaft 122. On the other hand, the second one-way clutch 162 becomes un-locked state when the rotation speed of the over-drive driven gear 149 is slower than the rotation speed of the second output shaft 122 to disconnect the over-drive driven gear 149 from the second output shaft 122.

When the first drive gear 131 is connected to the rotational member 115 by the first connecting mechanism 191, the over-drive driven gear 149 (connecting member) is rotatably connected to the rotational member 115. Under this connected state, when the rotation speed of the over-drive driven gear 149 becomes faster than the rotation speed of the second output shaft 122 by the driving force from the first motor/generator 11 or the engine 2, the second one-way clutch 162 becomes locked to connect the over-drive driven gear 149 with the second output shaft 122. In this case, the engine torque Te and the first motor torque Tm1 are transmitted to the drive wheels 21L and 21R via the second output shaft 122. On the other hand, when the rotation speed of the over-drive driven gear 149 becomes slower than the rotation speed of the second output shaft 122, the second one-way clutch 162 becomes un-locked to disconnect the over-drive driven gear 149 from the second output shaft 122.

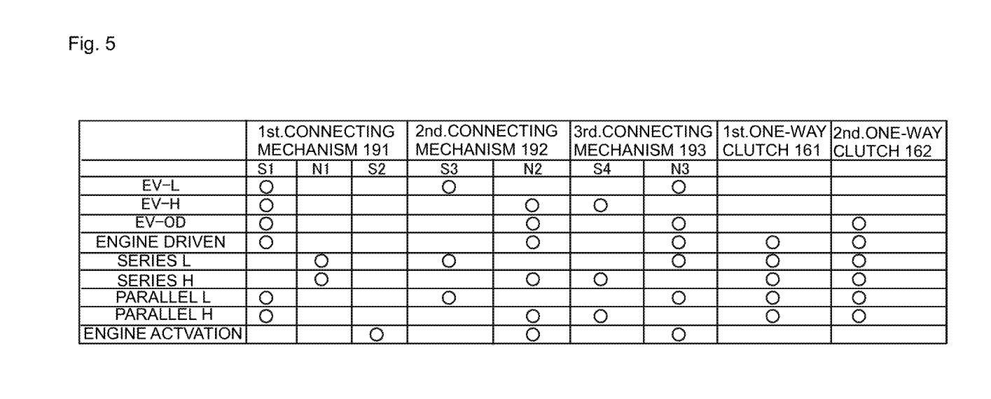

The control portion 18 outputs the instructions to the connecting mechanisms 191 through 193 to change the driving modes of the hybrid vehicle drive device 1 according to the engagement table shown in FIG. 5.

### Effects of Hybrid Vehicle Drive Device of Third Embodiment

In the hybrid vehicle drive device 1 according to the third embodiment, the second one-way clutch 162 operates such that the over-drive driven gear 149 and the second output shaft 122 are connected when the rotation speed of the over-drive driven gear 149 (connecting member) is faster than the rotation speed of the second output shaft 122. On the other hand, the second one-way clutch 162 disconnects the over-drive driven gear 149 from the second output shaft 122 when the rotation speed of the over-drive driven gear 149 is slower than the rotation speed of the second output shaft 122. The effects of the hybrid vehicle drive device 1 according to the third embodiment will be explained hereinafter.

According to the hybrid vehicle drive device 1 of the third embodiment, in the EV-L and EH-H modes, the first rotor 11a of the first motor/generator 11 is connected to the first drive gear 131. When the vehicle V is travelling by the driving force of the second motor/generator 12, if the driving force outputted from the second motor/generator 12 is not satisfactory to the required driving force, the first motor/generator 11 outputs the first motor torque Tm1. Then, the second one-way clutch 162 is locked to thereby automatically connect the first rotor 11a of the first motor/generator 11 with the second output shaft 122. Thus, the drive wheels 21L and 21R are driven by the first motor torque Tm1 from the first motor/generator 11. Since the first rotor 11a of the first motor/generator 11 has been connected to the first drive gear 131 in advance, if the driving force of the first motor/generator 11 becomes necessary, it is not necessary to connect the first rotor 11a of the first motor/generator 11 with the first drive gear 131 and the drive wheels 21L and 21R are driven instantly by the driving force of the first motor/generator 11.

On the other hand, if driving of the drive wheels 21L and 21R by the first motor/generator 11 becomes unnecessary, the second one-way clutch 162 becomes in an un-locked state and the first rotor 11a of the first motor/generator 11 is disconnected from the second output shaft 122. Therefore, energy loss caused by the rotation of the first rotor 11a of the first motor/generator 11 can be prevented.

Further, upon switching over operation between the EV-L mode and the EH-H mode, although the second motor/generator 12 is disconnected from the drive wheels 21L and 21R, the first motor/generator 11 can drive the drive wheels 211 and 21R to prevent the deceleration of the vehicle V.

### Other Embodiments

According to the embodiments explained above, the first to third connecting mechanisms 191 through 193 are formed by dog clutch. However, the connecting mechanisms 191 through 193 may be formed by synchronizer mechanisms. Further, the second and the third connecting mechanisms 192 and 193 may be operated by a common actuator.

### EXPLANATION OF REFERENCE NUMERALS

In the drawings:

2: engine, 11: first motor/generator, 12: second motor/generator, 111: first input shaft (input shaft), 115: rotational member, 121: first output shaft (output shaft), 122: second output shaft (output shaft), 125: first output shaft, 126: low speed side second output shaft (second output shaft), 127: high sped side second output shaft (second output shaft), 132: second drive gear (drive gear), 141: first driven gear, 142: second driven gear, 149: over-drive driven gear, 161: one-way clutch (first one-way clutch), 162: second one-way clutch, 191: first connecting mechanism, 192: second connecting mechanism, 193: third connecting mechanism. 21L, 21R: drive wheel, 21FL 21FR: front side drive wheels (one side drive wheels), 21RL, 21RR: rear side drive wheels (the other side drive wheels).

1. A hybrid vehicle drive device comprising:
a first motor/generator;
a second motor/generator;
an input shaft to which an engine is rotatably connected;
an output shaft which is roratably connected to a drive wheel and the second motor/generator;
a rotational member which is rotatably connected to the first motor/generator and the output shaft;
and a first one-way clutch which connects the input shaft and the rotational member when a rotation speed of the input shaft is faster than a rotation speed of the rotational member and disconnects the input shaft and the rotational member when the rotation speed of the input shaft is slower than the rotation speed of the rotational member.

2. The hybrid vehicle drive device according to claim 1, further comprising:
a first connecting mechanism which connects or disconnects the output shaft and the rotational member.

3. The hybrid vehicle drive device according to claim 2, wherein the first connecting mechanism connects or disconnects the input shaft and the rotational member.

4. The hybrid vehicle drive device according to any one of claims 1 through 3, further comprising:
a connecting member which is rotatably connected to the rotational member; and
a second one-way clutch which connects the connecting member and the output shaft when a rotation speed of the connecting member is faster than a rotation speed of the output shaft and disconnects the connecting member and the output shaft when the rotation speed of the connecting member is slower than the rotation speed of the output shaft. .

5. The hybrid vehicle drive device according to any one of claims 9 through 4, wherein
the output shaft is formed by a first output shaft and a second output shaft, the hybrid vehicle drive device further comprising:
a drive gear to which the second motor/generator is rotatably connected;
a first driven gear freely rotatably provided at the first output shaft and engaging with the drive gear;
a second driven gear freely rotatably provided at the second output shaft and engaging with the drive gear;
a second connecting mechanism which connects or disconnects the first driven gear and the first output shaft; and
a third connecting mechanism which connects or disconnects the second driven gear and the second output shaft.

6. A hybrid vehicle drive device comprising:
a first motor/generator;
a second motor/generator;
an input shaft to which an engine is rotatably connected;
a first output shaft which is rotatably connected to one of a front drive wheel and a rear drive wheel;
a second output shaft which is rotatably connected to the other of the front drive wheel and the rear drive wheel and the second motor/generator;
a rotational member which is rotatably connected to the first motor/generator and the first output shaft; and
a one-way clutch which connects the input shaft and a rotational member when a rotation speed of the input shaft is faster than a rotation speed of the rotational member and disconnects the input shaft and the rotational member when the rotation speed of the input shaft is slower than the rotation speed of the rotational member.
